(19) United States
(12) Patent Application Publication
(10) Pub. No.: US 2025/0062379 A1
(43) Pub. Date: Feb. 20, 2025

(54) Phase Stable Doped Cubic Bismuth Oxide and Methods For Producing and Using the Same

(71) Applicant: University of Maryland, College Park, College Park, MD (US)

(72) Inventors: Eric D. Wachsman, Fulton, MD (US); Adam Jolley, College Park, MD (US)

(73) Assignee: University of Maryland, College Park, College Park, MD (US)

(21) Appl. No.: 18/936,110

(22) Filed: Nov. 4, 2024

Related U.S. Application Data
(63) Continuation-in-part of application No. 18/623,682, filed on Apr. 1, 2024.
Application No. 18/623,682 is a continuation of application No. 17/990,664, filed on Nov. 19, 2022, now Pat. No. 11,978,938.
Application No. 17/990,664 is a division of application No. 16/521,462, filed on Jul. 24, 2019, now Pat. No. 11,539,065.
(60) Provisional application No. 62/702,730, filed on Jul. 24, 2018.

(51) Int. Cl. H01M 8/1246; H01M 8/12

(52) U.S. Cl. CPC H01M 8/1266; H01M 2008/1293; H01M 2300/002; H01M 2300/0074

(57) ABSTRACT

The present invention relates to a doped cubic bismuth oxide that is phase stable in a temperature range of from about 550° C. to about 700° C. The doped cubic bismuth oxide comprises a mixture of a first dopant and a second dopant.

### CROSS-REFERENCE TO RELATED APPLICATIONS

This application is continuation-in-part of U.S. patent application Ser. No. 18/623,682, filed Apr. 1, 2024, which is a continuation of U.S. patent application Ser. No. 17/990,664, filed Nov. 19, 2022, now U.S. Pat. No. 11,978,938, issued May 7, 2024, which is a divisional of U.S. patent application Ser. No. 16/521,462, filed Jul. 24, 2019, now U.S. Pat. No. 11,539,065, issued Dec. 27, 2022, which claims the priority benefit of U.S. Provisional Application No. 62/702,730, filed Jul. 24, 2018, all of which are incorporated herein by reference in their entirety.

### STATEMENT REGARDING FEDERALLY FUNDED RESEARCH

This invention was made with government support under DE-AR0000494 awarded by the U.S. Department of Energy. The government has certain rights in the invention.

### FIELD

The present invention relates to a doped cubic bismuth oxide that is phase stable in the temperature range of from about 550° C. to about 700° C. In particular, the doped cubic bismuth oxide of the disclosure has a higher conductivity than DWSB.

### BACKGROUND

Solid oxygen-ion conductors have a wide variety of applications in biomedical, semiconductor, chemical, transportation, and energy industries. One of the examples of applications of solid oxygen-ion conductors in transportation industries is the oxygen sensor used to control air/fuel ratios in automobile internal combustion engines for improved fuel economy as well as the oxygen-storage component of the three-way catalytic convertor that utilized that air/fuel ratio control to reduce the NOₓ, CO, and unburned hydrocarbons pollutants in automotive exhaust. Controlling oxygen atmospheres is also critical in fabrication of semiconductors and numerous industrial chemical reactions. Ability to separate oxygen from air provides concentrated O₂ and N₂ industrial gasses and the opportunity for greater combustion efficiency with the prevention of NOₓ formation. In addition, ceramic oxygen generators (COGs) have allowed people with limited lung capacity mobility by electrochemically concentrating the oxygen available in air. Recently this technology was extended in providing exo-planet life-support by electrolytically reducing CO₂ in the Martian atmosphere to breathable O₂.

In the energy sector, solid oxide fuel cells (SOFCs) are being developed and commercialized for conversion of hydrogen and hydrocarbon fuels to electric power with greater efficiency and thus lower greenhouse gas (GHG) emissions; however, to achieve the desired efficiency SOFC electrolytes not only need high ionic conductivity but stability and low electronic conductivity across a wide pO₂ range (0.21 to 10⁻²¹ atm). Unfortunately, the highest conductivity oxide electrolytes tend to have the lowest stability to reduction in low pO₂ atmospheres.

By using Ce_{0.8}Gd_{0.2}O₂ (GDC) and Bi_{1.6}Er_{0.4}O₃ (ESB) in a bilayer configuration the present inventor was previously able to achieve stability with two high conductivity oxygen-ion electrolytes resulting in record high SOFC power densities (2 W/cm²) for lower temperature (650° C.) operation. By substituting a more conductive Bi_{1.76}Dy_{0.16}W_{0.08}O₃ (DWSB) for the ESB electrolyte, an additional 75% improvement in performance, up to 3.5 W/cm² at 650° C., was projected to be achieved by the present inventor. These SOFCs have the potential to also operate in reverse as a solid oxide electrolysis cell (SOEC) for hydrogen production, and by combining SOEC and SOFC operation for long duration energy storage. A more general term used herein for all the above technologies is a solid oxide cell (SOC).

Unfortunately, the primary barrier to greater use of SOC technologies and development of new applications is the high temperatures (typically ≥800° C.) required for sufficient oxygen-ion conductivity. For example, traditional SOFCs/SOECs are comprised of a zirconia-based electrolyte that does not possess sufficient oxygen ion conductivity below 700° C. to generate high performance (see, for example, Arachi et al., Solid State Ionics 1999, 121, 133-139 and Skinner et al., Mater. Today 2003, 6, 30-37), whereas if the operational temperature was reduced to ≤600° C. manufacturing and processing costs and the mechanisms that cause degradation would be decreased concomitant with an increase in system efficiency (see, for example, Steele, J. Mater. Sci., 2001, 36, 1053-1068 and Wachsman et al., Science 2011, 80, 334).

Lowering the operational temperature of SOC will enable reduction in fabrication complexity and cost as well as faster start-up. Moreover, reduction in operational temperature of SOC would dramatically increase life-support applications, such as COGs, where the oxygen produced needs to be at ambient temperature for human consumption. Ultimately developing an electrolyte material that is stable at a relatively lower temperature with higher ionic conductivity would facilitate further application and development of SOCs.

Currently, among all solid oxygen-ion conductors the face centered cubic (FCC) phase of bismuth oxide (δ-81203) has exhibited the highest known oxygen ion conductivity of any material. See, for example, Jiang et al., Solid State Ionics, 2002, 150, 347-353 and Sammes et al., J. Eur. Ceram. Soc., 1999, 19, 1801-1826. Unfortunately, pure δ-Bi₂O₃ is not phase stable below 700° C. As a result, major research efforts in the 1980's were focused on stabilizing the cubic phase down to room temperature by doping rare earth cations into the Bi⁺³ site resulting in the development of ESB as the highest conductivity phase-stable oxygen-ion electrolyte. ESB held the record for decades until the present inventor and co-workers developed a co-doping strategy to stabilize δ-Bi₂O₃ with a reduced total dopant concentration in 2010 resulting in DWSB, which is the highest oxygen-ion conductivity material known to date. See, for example, Jung et al., Acta Mater., 2010, 58, 355-363 and Jung et al., J. Electrochem. Soc., 2016, 163, F411-F415.

Unfortunately, while the cubic phase of Bi₂O₃ can be stabilized down to room temperature, long range ordering of the anion sublattice is responsible for a considerable decay in conductivity when the electrolyte is annealed below 600° C. Jiang, N. et al., Mater. Lett., 1995, 22, 215-219. At temperatures above approximately 600° C., the oxygen vacancies in the cubic Bi₂O₃ lattice are disordered, while below 600° C. the oxygen vacancies order along the <111> direction and reduce the number of possible oxygen anion jump directions. Boyapati et al., Solid State Ionics, 2001, 140, 149-160. The decrease in anion equivalent jump directions causes a several orders of magnitude drop in conductivity that causes ESB and DWSB to be unsuitable as an SOC electrolyte below 600° C.

To avoid the instability that plagues the cubic phase of Bi₂O₃, other phases of Bi₂O₃ have been considered as SOC electrolytes. Unfortunately, the low conductivity of these materials usually renders them inadequate. Naturally occurring, low temperature polymorphs of bismuth oxide like β-Bi₂O₃ and γ-Bi₂O₃ display a conductivity that is orders of magnitude lower than the cubic phase. Harwig et al., J. Solid State Chem., 1978, 26, 265-274. The rhombohedral phase of Bi₂O₃ likewise exhibits much lower conductivity than the cubic phase. Takahashi et al., J. Appl. Electrochem., 1972, 2, 97-104 and Drache et al., J. Solid State Chem., 1999, 142, 349-359. The benefit of a lower symmetry phase of Bi₂O₃ resides in its stability at lower temperatures. Below 700° C., the rhombohedral phase of Bi₂O₃ has even been demonstrated to be thermodynamically favorable over the cubic phase, as the cubic lattice undergoes a transformation to the rhombohedral lattice when annealed for hundreds of hours. Fung et al., J. Am. Ceram. Soc., 1993, 76, 2403-2418 and Joshi, J. Mater. Sci., 1990, 25, 1237-1245.

Therefore, there is a continuing need for developing a stable conductivity solid electrolyte that can operate efficiently at a relatively lower operating temperature.

### SUMMARY

Some aspects of the disclosure are based on the discovery by the present inventors of a stable doped cubic Bi₂O₃ electrolyte having a high conductivity. One particular aspect of the disclosure provides a doped cubic bismuth oxide composition that is phase stable in a temperature range of from about 550° C. to about 700° C. The doped cubic bismuth oxide of the disclosure comprises a mixture of a first dopant and a second dopant. In some embodiments, a total amount of said first and said second dopant is about 15 mole % or less of a total metal content. Still in other embodiments, a total amount of said first and said second dopant is about 10 mole % or less of a total metal content.

Yet in other embodiments, said doped cubic bismuth oxide has a higher conductivity than Bi_{1.76}Dy_{0.16}W_{0.08}O₃ (DWSB) at 650° C. In some instances, said doped cubic bismuth oxide has at least about 20% higher conductivity than Bi_{1.76}Dy_{0.16} W_{0.08}O₃ (DWSB) at 650° C. Still in other instances, said doped cubic bismuth oxide has at least about 30% higher conductivity than Bi_{1.76}Dy_{0.16}W_{0.08}O₃ (DWSB) at 650° C.

Still in further embodiments, said first dopant comprises La, Ce, Pr, Pa, U, or a mixture thereof. In other embodiments, said second dopant comprises Zr, Y, Nb, Sn, Hf, Ta, W, or a combination thereof.

In further embodiments, said doped cubic bismuth oxide is stable at 650° C. for at least 100 hours. As used herein, the term “stable” means the doped cubic bismuth oxide of the disclosure does not exhibit conductivity decay or decrease of 5% or more after 100 hours at 650° C.

Yet still in other embodiments, the total amount of said first and said second dopant in said doped bismuth oxide comprises about 10 mole % or less of the total metal content. Still in other embodiments, the amount of said first dopant ranges from about 2 mole % to about 8 mole % of the total metal content. In other embodiments, the amount of said second dopant is about 3 mole % or less of the total metal content.

Other aspects of the disclosure provide a solid-oxide cell (SOC) electrolyte comprising a doped cubic bismuth oxide composition disclosed herein. In some embodiments, the SOC electrolyte of the disclosure has an electrical conductivity of at least about 0.58 S/cm at a temperature of about 650° C. for at least about 100 hours.

Still other aspects of the disclosure provide a solid oxide fuel cell (SOFC) comprising a solid oxide cell electrolyte disclosed herein.

Further aspects of the disclosure provide a doped bismuth oxide composition comprising δ-phase bismuth oxide doped with a mixture of a first dopant and a second dopant. In some embodiments, the total amount of said first and said second dopant in said doped bismuth oxide comprises about 15 mole % or less of a total metal content. Still in other embodiments, said δ-phase bismuth oxide is stable at a temperature range of from about 550° C. to about 700° C. In other embodiments, said doped bismuth oxide is phase stable for at least 100 hours at a temperature of about 650° C. In one particular embodiment, said δ-phase bismuth oxide is phase stable for at least 100 hours at 650° C.

### BRIEF DESCRIPTION OF THE DRAWINGS

FIG. 1 is room temperature X-ray diffraction patterns of 10% La and Y doped Bi₂O₃ materials.

FIG. 2 is room temperature X-ray diffraction patterns of 10% La and Zr doped cubic Bi₂O₃ materials. The La₂Zr₂O₇ impurity phase is indicated with triangles.

FIG. 3 is a graph of EIS data for the La1.5Y8.5 sample from 700° C.-500° C. Lines are the fits of the impedance data.

FIG. 4 is a graph of EIS data for the La7Zr3 sample from 700° C.-500° C. Lines are the fits of the impedance data.

FIG. 5 is a graph of conductivity as a function of temperature for multiple cubic Bi₂O₃ electrolytes. The DWSB and ESB samples are plotted as reference cubic oxide materials.

FIG. 6 is an Arrhenius plot of multiple SOFC electrolytes from 700° C. to 400° C. The activation energy of the rhombohedral La5.1Y1.4 sample is 0.867 eV. The high temperature activation energy of the cubic La7Zr3 sample is 0.520 eV and the low temperature activation energy is 0.847 eV. Plot adapted from Lee et al., J. Mater. Res., 2012, 27, 2063-2078.

FIG. 7 is a graph of conductivity as function of aging time for La7Zr3 and DWSB at 650° C. The DWSB is plotted as a reference cubic bismuth oxide material.

FIG. 8 is a schematic illustration showing transport of oxygen ions in cubic Bi₂O₃ crystal structure, left is ordered structure below 600° C. and right is disordered structure above 600° C.

FIG. 9 is a graph of conductivity as function of aging time for La5.1Y1.4, DWSB and ESB at 500° C. The DWSB and ESB samples are plotted as reference cubic oxide materials.

FIG. 10 shows room temperature X-ray diffraction pattern of cubic La7Zr3 before and after aging at 500° C. for 100 hours. The black line is the initial XRD plot and the dashed red line is after aging. The intensity of the secondary phase La₂Zr₂O₇ peaks grew after aging.

FIG. 11 is a graph showing conductivity as a function of aging time for 10% La and Y doped Bi₂O₃ compounds at 500° C.

FIG. 12 shows room temperature X-ray diffraction pattern of cubic La1.5Y8.5 before and after aging at 500° C. for 60 hours. The black line is the initial XRD plot and the red dashed line is after aging.

FIG. 13 shows room temperature X-ray diffraction pattern of rhombohedral La3.6Y6.4 before and after aging at 500° C. for 60 hours. The black line is the initial XRD plot and the dashed red line is after aging.

FIG. 14 is a graph showing decay in conductivity (Eq. 1) vs. average dopant ionic radius for 10% La and Y doped Bi₂O₃ at 500° C. Plotted on the second axis is the rhombohedral/cubic phase fraction determined by room temperature XRD and Rietveld refinement.

FIG. 15 shows EIS data for the La5.1Y1.4 sample from 550° C.-450° C. The black lines are the fits of the impedance data.

FIG. 16 is a schematic illustration showing transport of oxygen ions in rhombohedral Bi₂O₃ with 3D diffusion network in the ab plane and across the ab plane.

FIG. 17 is a graph showing conductivity vs. average dopant ionic radius for 10% La and Y doped rhombohedral Bi₂O₃ measured at 500° C. The second vertical axis indicates the volume of the rhombohedral unit cell as determined by room temperature XRD and Rietveld refinement. The dotted lines indicate the approximate stability window of single rhombohedral phase.

FIG. 18 is a graph showing conductivity vs. total dopant concentration for La and Y doped rhombohedral Bi₂O₃ measured at 500° C. The average dopant ionic radius was held constant at 1.12 Å. The dotted line indicates the approximate single phase rhombohedral boundary as determined by room temperature XRD and Rietveld refinement. The solid line is the linear fit of the data.

FIG. 19 is a graph showing high temperature X-ray diffraction of La5.1Y1.4. Temperature of each scan is indicated on the plot. The peak shift indicates a rhombohedral to cubic phase transition above 580° C.

FIG. 20 is a graph showing conductivity as a function of aging time for La5.1Y1.4. The temperature of aging is given on the plot.

FIG. 21 is an EIS plot of a La5.1Y1.4 symmetric cell at 500° C. The atmosphere suppled to the “anode” side is indicated as an oxygen concentration on the plot.

FIG. 22 is a graph showing voltage measurements at different “anode” PO₂ values for a La5.1Y1.4 symmetric cell at 500° C. The “cathode” side of the symmetric cell is steadily supplied with air. The secondary axis indicates the ionic transference number of La5.1Y1.4 as a function of “anode” PO₂ at 500° C.

### DETAILED DESCRIPTION

When referring to a numerical value, the terms “about” and “approximately” are used interchangeably herein and refer to being within an acceptable error range for the particular value as determined by one of ordinary skill in the art, which will depend in part on how the value is measured or determined, e.g., the limitations of the measurement system, i.e., the degree of precision required for a particular purpose. For example, the term “about” typically means within 1 standard deviation, per the practice in the art. Alternatively, the term “about” can mean ±20%, typically ±10%, often ±5% and more often ±1% of the numerical value. In general, however, where particular values are described in the application and claims, unless otherwise stated, the term “about” means within an acceptable error range for the particular value.

The term “stable” when referring to a phase of bismuth oxide means that at least about 75%, typically at least about 80%, often at least about 90%, more often at least about 95%, and most often at least about 98% of the initial crystal lattice structure of bismuth oxide is maintained under the given conditions. For example, at 550° C. for at least 100 h, typically at least 150 h, often at least about 200 h, and most often at least 300 h. Alternatively, at 650° C. for at least 100 h, typically at least 150 h, often at least about 200 h, and most often at least 300 h. Still in other embodiments, the term “stable” refers to having about 15% or less, typically 7% or less, often 5% or less, and most. often 3% or less decay in conductivity at 650° C. In another embodiment, the term “stable” refers to ability of bismuth oxides of the disclosure to maintain conductivity with no or minimal decay. For example, in some embodiments the term “stable” means bismuth oxides of the disclosure maintain stable conductivity within given conditions. with no more than about 25%, typically no more than about 20%, often no more than about 15%, more often no more than about 10%, and most often no more than about 5% loss or decay in conductivity (e.g., at 550° C. for at least 100 h, typically at least 150 h, often at least about 200 h, and most often at least 300 h).

The term “phase stable” refers to the crystal structure that does not change or changes no more than about 25%, typically no more than about 20%, often no more than about 15%, more often no more than about 10%, and most often no more than about 5% of at 650° C. after at least about 100 h, typically after at least about 150 h, often after at least about 200 h, and most often after at least 300 h.

Higher conductivity electrolytes are important for the reduction of operating temperature and increased viability of numerous solid-state oxygen-ion conducting technologies. Unfortunately, the highest oxygen ion conducting electrolyte, doped cubic bismuth oxide, is currently only useable above 600° C. Disclosed herein are tailored structures of doped bismuth oxide electrolytes that allow functionality at both high and low temperatures. At higher temperatures (e.g., ≥600° C.), a doped cubic Bi₂O₃ disclosed herein resulted in the highest oxygen-ion conductivity ever recorded to date for a phase stable electrolyte. Meanwhile, a doped rhombohedral Bi₂O₃ electrolyte disclosed herein showed exceptional stability, exhibiting no observable conductivity decay for 100 hours of aging at 500° C., thus making it the highest oxygen ion conducting electrolyte known with stable performance for lower temperature solid oxide cells (SOCs).

Solid oxide fuel cells (SOFCs) are a promising technology for efficient and high power energy conversion of hydrocarbon fuels. One of the main barriers to commercialization and widespread use is the high temperatures (≥800° C.) required for operation. Currently, the highest oxygen ion conducting electrolyte, cubic bismuth oxide, is only useable above 650° C. due to structural instability below this temperature.

Above approximately 730° C., pure Bi₂O₃ exists in the face centered cubic phase (FCC or δ-cubic) and exhibits a greater oxygen ion conductivity than any known oxygen ion conductor. As the operating temperature reaches below 730° C., Bi₂O₃ transitions through a set of lower symmetry phases including the monoclinic phase, which ultimately lowers the ionic conductivity by orders of magnitude. Traditionally, cations with a smaller ionic radius than Bi⁺³ are used to stabilize the high symmetry δ-cubic phase to room temperature to protect the highly conductive cubic phase. Although this substituted δ-cubic phase exhibits superior conductivity initially, below approximately 600° C. the oxygen ion sub-lattice begins to order and the ionic conductivity drops significantly over time. For example, 20% Er-doped Bi₂O₃ (ESB) is a standard doped Bi₂O₃ electrolyte in the δ-cubic phase that undergoes oxygen ion ordering, making it a poor candidate for a high performing solid oxide fuel cells (SOFCs) below 600° C. due to the inherent degradation of conductivity.

By decreasing the operational temperature below 600° C., it is possible to achieve reduced manufacturing and processing costs, an increase in theoretical efficiency, and a decrease in the mechanisms that cause degradation.

Some aspects of the disclosure are based on the discovery by the present inventors of stable conductivity electrolytes that can operate efficiently at a relatively lower operating temperature, e.g., about 650° C. or lower, typically about 600° C. or lower, and often about 550° C. or lower. Other aspects of the disclosure are based on the discovery by the present inventors that the phase of Bi₂O₃ is dependent on the size and amount of dopant present in the lattice. In particular, the present inventors have noticed that utilizing a particular average radius (e.g., <1.07 Å) of double dopants, as shown in Table 1, favors the δ-cubic phase, while an average radius of >1.07 Å of double dopants appears to favor the rhombohedral phase.

One particular aspect of the disclosure provides a stable doped δ-Bi₂O₃ having a high conductivity and stable performance at intermediate temperatures (e.g., 650° C.). In some embodiments, the dopant comprises a first dopant and a second dopant. Unlike ESB and DWSB, the total amount of metal dopants in this stable doped δ-Bi₂O₃ is less than about 20%, typically about 15% or less, and often about 10% or less relative to the total metal content. In other embodiments, the relative dopant ionic radius ranges from about 1.00 Å to about 1.10 Å, typically from about 1.00 Å to about 1.09 Å, often from about 1.01 Å to about 1.08 Å, more often from about 1.02 Å to about 1.07 Å, and most often from about 1.03 Å to about 1.07 Å. Typically, the first dopant has a relatively large ionic radius, whereas the second dopant has a relatively smaller ionic radius. The ionic radius of dopants can be readily determined by one skilled in the art having read the present disclosure.

The doped cubic bismuth oxide composition of the disclosure is phase stable in a temperature range of from about 550° C. to about 700° C., typically from about 550° C. to about 675° C., often from about 575° C. to about 675° C., more often from about 575° C. to about 650° C., and most often from about 600° C. to about 650° C. The doped cubic bismuth oxide of the disclosure comprises a mixture of a first dopant and a second dopant. In some embodiments, a total amount of said first and said second dopant is about 15 mole % or less of a total metal content. Still in other embodiments, a total amount of said first and said second dopant is about 10 mole % or less of a total metal content. In some embodiments, said first dopant ranges from about 1 mole % to about 9 mole %, typically from about 2 mole % to about 8 mole %, often from about 2 mole % to about 7 mole % of the total metal content. Still in other embodiments, the amount of said second dopant is about 8 mole % or less, typically about 6 mole % or less, often about 5 mole % or less, and most often about 3 mole % or less of the total metal content. In one particular embodiment, the first dopant comprises about 6-8 mole % and the second dopant comprises about 4-2 mole %, respectively, of the total metal content. Yet in other embodiments, the amount of said second dopant is about 3 mole % or less of the total metal content.

Yet in other embodiments, the first dopant comprises a cation of a lanthanide or an actinide series having a relatively large ionic radius, e.g., at least about 0.95 Å, typically at least about 1.00 Å, often at least about 1.01 Å, more often at least about 1.02 Å, still more often at least about 1.03 Å, and most often at least about 1.04 Å. In some embodiments, the first dopant comprises La, Ce, Pr, Pa, U, or a mixture thereof.

In some embodiments, the second dopant typically has a smaller ionic radius relative to the first dopant. In one particular embodiment, the ionic radius of the second dopant is about 1.00 Å or less, typically 0.98 Å or less, often 0.95 Å or less, more often 0.93 Å or less, still more often about 0.91 Å or less, and most often about 0.89 Å or less. In one particular embodiment, the second dopant comprises Zr, Y, Nb, Sn, Hf, Ta, W, or a combination thereof.

Surprisingly and unexpectedly, the doped cubic bismuth oxide of the disclosure has a significantly higher conductivity than Bi_{1.76}Dy_{0.16}W_{0.08}O₃ (DWSB) at 650° C. In some instances, the doped cubic bismuth oxide of the disclosure has at least about 10%, typically at least about 15%, often at least about 20%, more often at least about 25%, and most often at least about 30% higher conductivity than DWSB at 650° C. In further embodiments, said doped cubic bismuth oxide is stable at 650° C. for at least 100 hours. In one particular embodiment, the doped cubic bismuth oxide does not exhibit conductivity decay or decrease of 5% or more after 100 hours at 650° C.

Yet in other embodiments, the doped cubic bismuth oxide composition disclosed herein has conductivity of at least about 0.56 S/cm, typically at least about 0.57 S/cm, often at least about 0.58 S/cm, and most often at least about 0.59 S/cm at a temperature of about 650° C. for at least about 100 hours.

The polarizability of bismuth is higher than the dopant cations. Thus, in contrast to conventional methods where a relatively large amount (e.g., 20 mole % or higher) of dopants are used, by decreasing the total cation substitution resulted in increased lattice polarizability, thereby allowing for greater oxygen ion mobility and facilitated anion diffusion. Without being bound by any theory, it is believed that higher polarizability results in larger cation charge separation and improved anion diffusion due to the reduction in coulombic repulsion that oxygen ions experience when moving through the saddle point of the conductivity pathway. Accordingly, some aspects of the disclosure relate to increasing conductivity of doped bismuth oxide by using less than about 20 mole %, typically about 15 mole % or less, often about 10 mole % or less, and more often less than 10 mole % of the total dopant.

The doped bismuth oxides of the disclosure can be used in any of the application disclosed herein including in a wide variety of electronic devices such as, but not limited to, solid state gas sensors (e.g., to control air/fuel ratio and control emissions), ion-transport membranes for oxygen separation and purification (e.g., for biomedical and aerospace application), batteries, components of batteries (e.g., as a cathode). Other uses for bismuth oxides of the invention are readily recognized by one skilled in the art having read the present disclosure.

Additional objects, advantages, and novel features of this invention will become apparent to those skilled in the art upon examination of the following examples thereof, which are not intended to be limiting.

### Examples

The fabrication of all materials followed a standard solid state synthesis route. The raw materials include Bi₂O₃ (Alfa Aesar 99.99%), ZrO₂ (Sigma Aldrich 99.9%), La₂O₃ (Alfa Aesar 99.99%), and Y₂O₃ (Alfa Aesar 99.9%). To begin, a stoichiometric ratio of precursor powders were ball milled in ethanol for 24 hours. The resulting slurry was dried prior to calcination at 800° C. for 16 hours with a heating and cooling rate of 5° C./minute. After cooling, the calcined powder was initially ground in a mortar in pestle and ball milled for another 24 hours in ethanol. Once complete, the slurry was dried and the emerging powder was compacted into disks using a uniaxial press and sintered at 800° C. for 16 hours with a heating and cooling rate of 5° C./minute.

X-ray diffraction (XRD) patterns were collected using a Bruker D8 X-ray Diffractometer with Cu Kα radiation. High temperature XRD patterns were collected Rietveld refinement was performed on the XRD data to extract the lattice parameters of all materials. In-situ high temperature XRD studies were done on a Bruker C2 Discover X-ray Diffractometer with Cu Kα radiation and 2D area detector. An Anton Paar DHS 1100 hot stage was used for sample heating on top of platinum foil.

Conductivity measurements were performed using electrochemical impedance spectroscopy (EIS). Gold paste was used as the current collector and painted on the faces of sintered disks. Four silver wires were affixed to the sample faces and used as the working and counter electrodes, as well as the two reference electrodes. The AC impedance was measured using a Solartron 1260A frequency response analyzer with a Solartron 1470E acting as a multiplexer. A frequency range of 1 MHz to 10 Hz and an AC voltage of 50 mV was used for EIS measurements. All impedance data was analyzed and fit with Scribner Zview software using equivalent circuit modeling approach.

The transference number was calculated from the OCV measured across the electrolyte sample in a two-gas environment. Silver paste was applied to both faces of the sintered disk and acted as electrodes for the measurements. The sample was placed between two gas lines and secured with a compressive seal made from Thermicullite 866 O-rings. One gas line supplied air, while the other gas line supplied gas mixtures with a range of PO₂ values. An oxygen sensor was used downstream to measure the exact PO₂ being supplied to the sample.

Ab initio molecular dynamics (AIMD) simulations were performed using the Vienna Ab initio Simulation package (VASP) within the projector augmented-wave approach with Perdew-Burke-Ernzerhof (PBE) generalized-gradient approximation (GGA). A supercell model with Γ-centered k-point in the non-spin-polarized DFT calculations. The time step was set to 2 fs, and NVT ensemble using Nosé-Hoover thermostat was adopted. The total time of AIMD simulations were 100 to 300 ps until a significant number of O-ion jumps were observed. The ionic conductivity was calculated using the established method. See, for example, //dx.doi.org/10.1039/c5cp02181b and //doi.org/10.1038/s41524-018-0074-y.

### Results

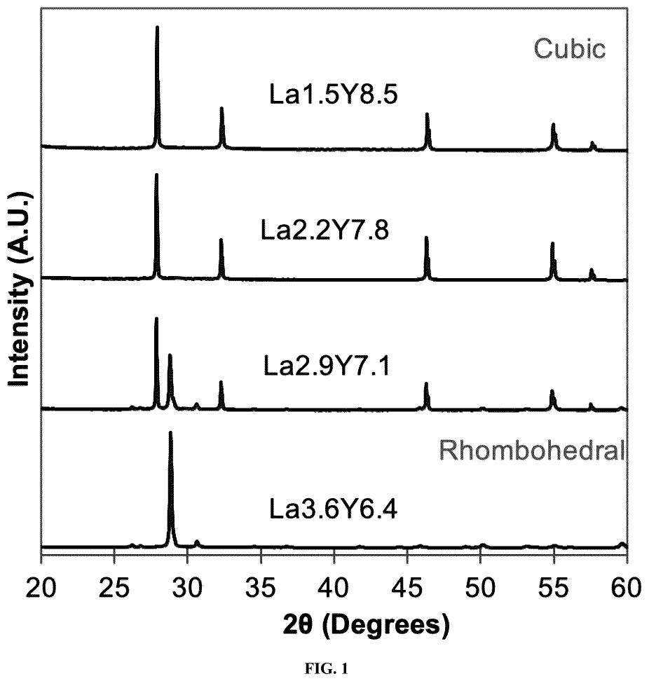

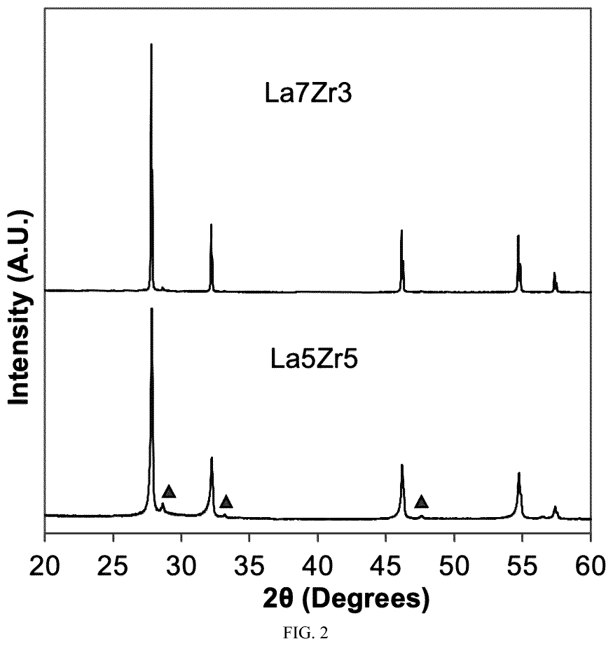

Bi₂O₃ electrolytes for intermediate temperature SOC operation: Double doped δ-Bi₂O₃ was explored as an SOC electrolyte due to its high conductivity and stable performance at intermediate temperatures (650° C.). Two materials discussed herein illustrates the scope of the disclosure. These two illustrative materials include: the La and Y double doped Bi₂O₃ and La and Zr double doped Bi₂O₃. The La⁺³ cation was selected as a dopant due to its large radius, and Y⁺³ and Zr⁺⁴ were selected as co-dopants due to their relatively smaller ionic radius. Without being bound by any theory, it is believed that these smaller secondary dopants were needed to stabilize δ-Bi₂O₃, as the ionic radius of La⁺³ is too large to stabilize the cubic phase on its own. The ionic radius of all dopants was determined from Shannon radii for a coordination eight cation. Since two cations were substituted into the Bi₂O₃ lattice, a weighted average of the two dopant's radius was used to calculate the relative dopant ionic radius. Table 1 lists the Bi₂O₃ compound, relative ionic radius, and phase for each sample synthesized. The room temperature X-ray diffraction (XRD) patterns of the double doped bismuth oxide materials are shown in FIGS. 1 and 2.

TABLE 1
Bi₂O₃ compositions, relative ionic radius,
and phase based on room temperature XRD.

| | | Relative Dopant | |
|---|---|---|---|
| Name | Composition | Ionic Radius (Å) | Phase |
| La1.5Y8.5 | Bi_{0.9}La_{0.015}Y_{0.085}O_{1.5} | 1.04 | cubic |
| La2.2Y7.8 | Bi_{0.9}La_{0.022}Y_{0.078}O_{1.5} | 1.05 | cubic |
| La2.9Y7.1 | Bi_{0.9}La_{0.029}Y_{0.071}O_{1.5} | 1.06 | cubic/ |
| | | | rhombohedral |
| La3.6Y6.4 | Bi_{0.9}La_{0.036}Y_{0.064}O_{1.5} | 1.07 | rhombohedral |
| La5.1Y1.4 | Bi_{0.9}La_{0.051}Y_{0.014}O_{1.5} | 1.13 | rhombohedral |
| La7Zr3 | Bi_{0.9}La_{0.07}Zr_{0.03}O_{1.5} | 1.065 | cubic |
| La5Zr5 | Bi_{0.9}La_{0.05}Zr_{0.05}O_{1.5} | 1.00 | cubic |

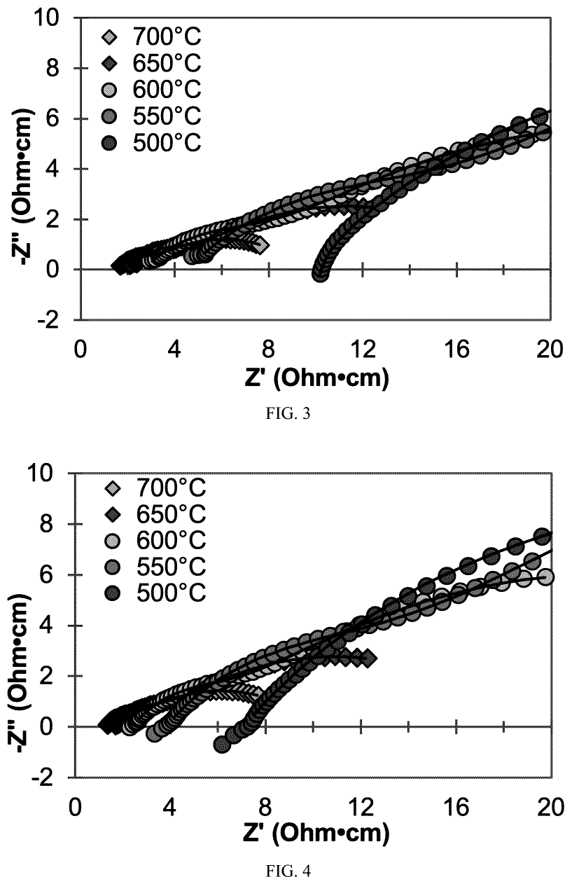

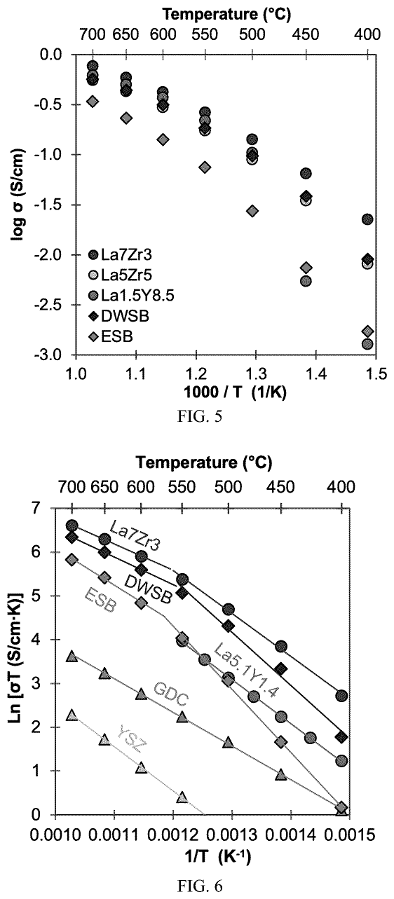

The ionic conductivity of the materials were measured using electrochemical impedance spectroscopy (EIS) on sintered pellets. The EIS data, the modeling and fits of the data, and the conductivity as a function of temperature of the cubic Bi₂O₃ materials are shown in FIGS. 3-5. Overall, the La7Zr3 compound exhibited the highest conductivity of all Bi₂O₃ materials synthesized in this investigation. The Arrhenius behavior of the cubic La7Zr3 is compared to other oxygen ion conductors in FIG. 6. The conductivity of La7Zr3 compound exceeds all other oxygen ion conducting materials developed to date. The conductivity of La7Zr3 is over 30% higher than DWSB at 650° C., which previously held the record for highest oxygen ion conductivity. In fact, the cubic La7Zr3 material is the fastest phase-stable oxygen-ion conducting material ever developed. The superior conductivity of the La7Zr3 electrolyte would permit further increase in Bi₂O₃ layer thickness and reduction of the less conductive electrolyte layer (GDC, SNDC, etc.) to minimize the ohmic area specific resistance (ASR) of an SOC without sacrificing OCV. Furthermore, the higher ionic conductivity and conductivity stability of La7Zr3 at 650° C. (FIG. 7) makes it appealing for long term operation of an SOC at that temperature.

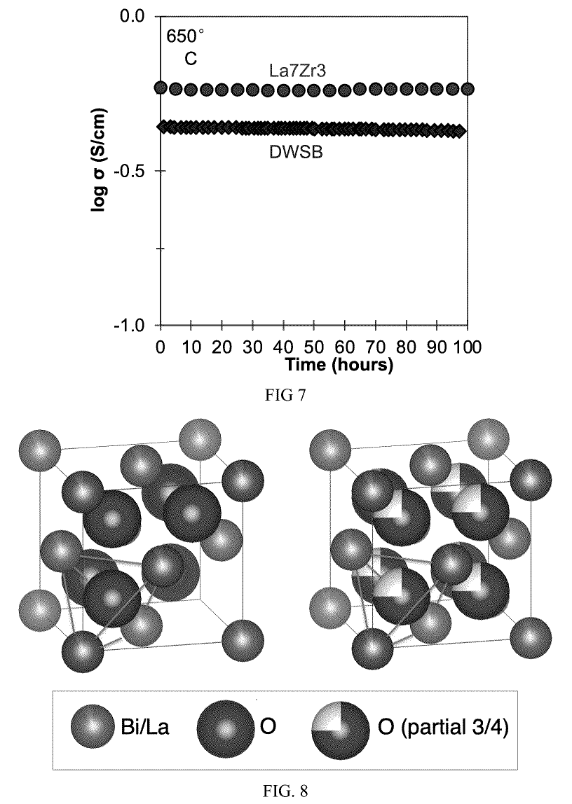

Like DWSB, the high conductivity in La7Zr3 was an outcome of lowering the total dopant concentration in Bi₂O₃, while also retaining the highly conductive cubic phase. The conductivity of La7Zr3 was improved beyond DWSB by reducing the total dopant concentration to 10%, providing a larger concentration of highly polarizable Bi⁺³ in the lattice. Because the polarizability of bismuth is higher than the dopant cations, decreasing the total cation substitution increased the lattice polarizability, consequently allowing for greater oxygen ion mobility and facilitated anion diffusion. Higher polarizability equates to larger cation charge separation and improved anion diffusion due to the reduction in coulombic repulsion that oxygen ions experience when moving through the saddle point of the conductivity pathway. The path of anion transport through the highly polarizable cation network is illustrated in FIG. 8. In ab initio molecular dynamics (AIMD) simulations on the cubic La7Zr3, this path of O²⁻ migration was directly observed (FIG. 8). In addition, the O-ion conductivity of cubic La7Zr3 is predicted to be 0.5 S/cm at 650° C. by the AIMD simulations, in good agreement with experimental measured values.

The cubic La7Zr3 sample exhibited better conductivity than all other 10% substituted Bi₂O₃ compounds investigated. The lanthanum cation has the largest ionic radius of all lanthanide series cations, and since the ionic radius is linearly related to polarizability, the large La⁺³ cation is more polarizable than the other rare earth elements. The La7Zr3 compound contained over four times more lanthanum than the La1.5Y8.5 sample for a similar dopant ionic radius (Table 1). The higher lanthanum content imparted greater polarizability and thus conductivity for the La—Zr doping vs. La—Y doping. Unfortunately, at higher zirconium concentrations, there was a marked increase in La₂Zr₂O₇ impurity phase formation. The substantial secondary phase within the La5Zr5 compound was most likely responsible for the decreased ionic conductivity compared to the La7Zr3 compound.

Bi₂O₃ Electrolytes for Low Temperature SOC Operation

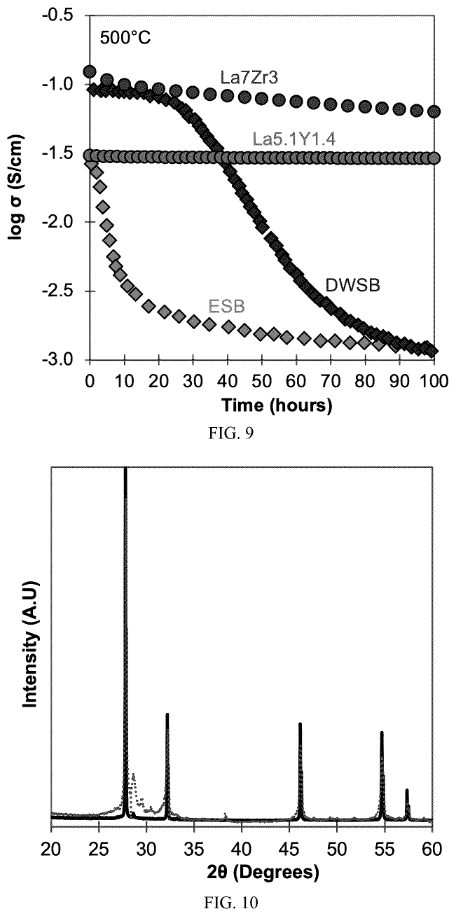

Tailoring the electrolyte for SOC operation at low temperatures (<600° C.) was also a priority of this investigation. While cubic Bi₂O₃'s generally displays stable performance at intermediate temperature, degradation at lower temperatures is a problem for SOCs operating below 650° C. In particular, anion ordering is most rapid in cubic Bi₂O₃ at 500° C. To ensure the Bi₂O₃ electrolytes were capable of operation at low temperatures, the samples were aged for one hundred hours at 500° C. Both ESB and DWSB exhibit a sharp decay in conductivity. The La7Zr3 compound meanwhile had a much more gradual decay in conductivity as it was aged at 500° C. (FIG. 9). It has been reported that the disorder-order transition in Bi₂O₃ can be suppressed with aliovalent doping of Zr⁺⁴ cations. Fung et al., J. Am. Ceram. Soc., 1993, 76, 2403-2418. Thus, La7Zr3 may undergo a much slower aging phenomenon than other cubic bismuth oxide materials doped with rare earth cations. The decline in conductivity though, was likely exacerbated by phase instability at 500° C. After a 100 hour hold at 500° C., there was a growth in a La₂Zr₂O₇ secondary phase, which is illustrated by the room temperature XRD pattern of La7Zr3 before and after aging as shown in FIG. 10. The lower conductivity after aging can in part be attributed to La and Zr dopants leaving the Bi₂O₃ solid solution to form the La₂Zr₂O₇ impurity phase.

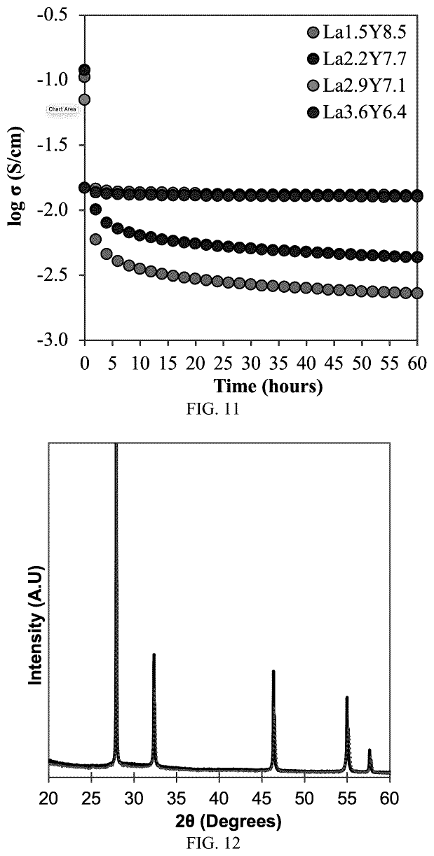

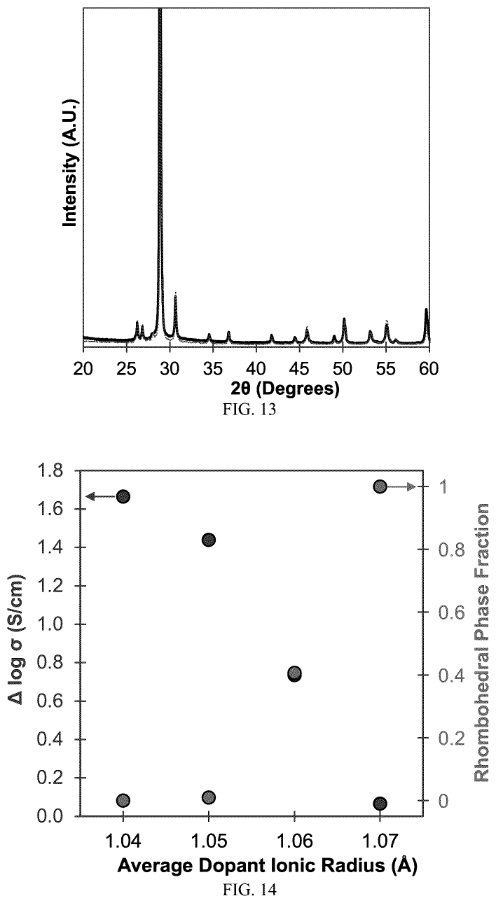

Although the cubic La7Zr3 compound exhibited a reduced decay in conductivity at 500° C. compared to ESB and DWSB, the conductivity decay would still degrade long term performance of an SOFC. Thus, the rhombohedral phase of double doped Bi₂O₃ was investigated for SOCs operating at low (<600° C.) temperature. The conductivity stability of La1.5Y8.5, La2.2Y7.8, La2.9Y7.1, and La3.6Y6.4 compounds were tested at 500° C. These four materials were selected as they ranged from pure cubic phase to entirely rhombohedral. The aging behavior of these compounds at 500° C. and the phase stability before and after aging for cubic La1.5Y8.5 and rhombohedral La3.6Y6.4 are shown in FIGS. 11-13. The degradation of conductivity for 10% La and Y substituted Bi₂O₃ was clearly affected by the average dopant ionic radius and phase of the material as shown in FIG. 14. Overall, the extent of conductivity degradation was directly correlated to the relative dopant ionic radius, and thus the cubic/rhombohedral phase fraction present in Bi₂O₃. The degradation of conductivity due to aging is modeled by Eq 1, where σᵢ is the initial conductivity measured at 500° C. and of is the final conductivity measured after 60 hours of aging at 500° C.

$$Δ log ( σ ) = log ( {σ}_{i} ) - log ( {σ}_{f} ) \qquad Eq . 1$$

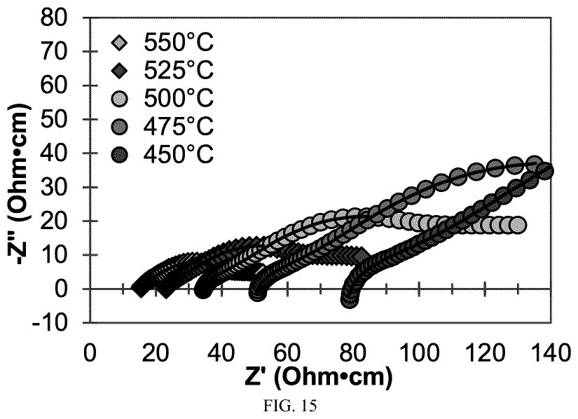

Ultimately, La5.1Y1.4 provided the highest conductivity of all rhombohedral Bi₂O₃ materials developed to date. The Arrhenius behavior of rhombohedral La5.1Y1.4 is compared to other SOC electrolyte materials in FIG. 6. The EIS data and fits are shown in FIG. 15. The conductivity of La5.1Y1.4 is superior to traditional electrolytes, and comparable to ESB over the stable range of the rhombohedral phase, and is in fact higher than ESB for temperatures <525° C. Only the highly conductive cubic double doped bismuth oxide electrolytes exhibited higher conductivity than La5.1Y.4.

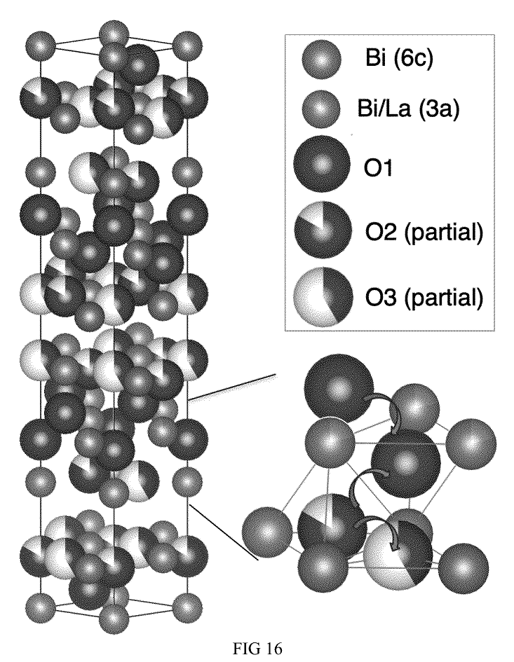

AIMD simulations were performed on this new rhombohedral La5.1Y1.4 to study O-ion transport. As directly observed in AIMD simulations, the rhombohedral structure exhibits a fast three-dimensional O-ion conduction network, where O ions jump between O2 and O3 sites in the ab plane and also jump across planes through O1 sites (FIG. 16). In addition, AIMD simulation also predicted a high O-ion conductivity of 0.4 S/cm at 550° C., which also agree with high conductivity values measured in experiments.

Moreover, the stability of rhombohedral La5.1Y1.4 provides a clear advantage over other electrolytes. FIG. 9 illustrates the conductivity of La5.1Y1.4 as a function of aging time at 500° C. The La5.1Y1.4 sample exhibited no appreciable decay over the one hundred hours of aging, while both ESB and DWSB experienced over an order of magnitude drop in conductivity. The performance of La5.1Y1.4 marks a critical point for Bi₂O₃ electrolytes. The rhombohedral La5.1Y1.4 compound is the first Bi₂O₃ material to exhibit ionic conductivity higher than ESB, without a decay in the conductivity at low temperature. In fact, La5.1Y1.4 has the highest stable oxygen ion conductivity ever measured at 500° C.

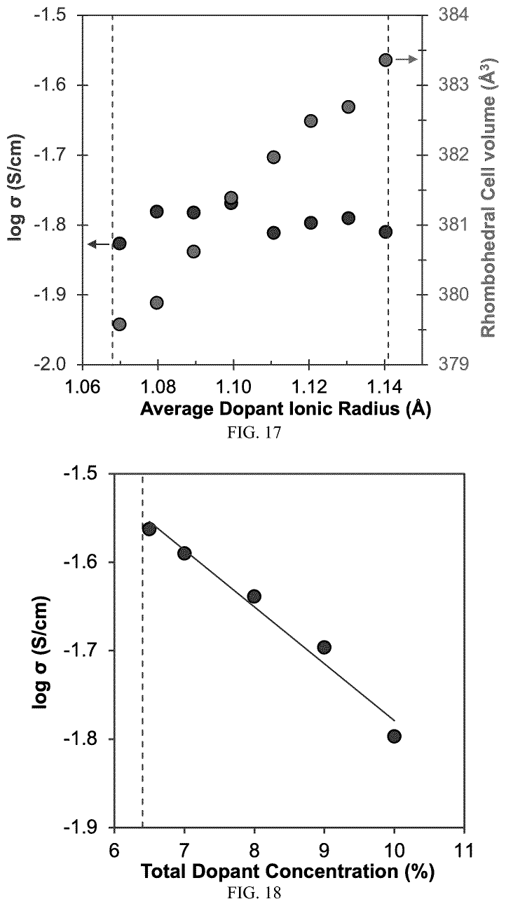

To further understand the effect of total dopant concentration and dopant ionic radius on the conductivity of rhombohedral Bi₂O₃, the amount of La and Y substitution was varied. Optimization began with varying the ratio of La to Y substitution at a fixed total dopant concentration of 10%. For the 10% La and Y doped Bi₂O₃, the pure rhombohedral phase was present from a relative dopant ionic radius of 1.07 Å up to 1.14 Å. The conductivity of 10% rhombohedral Bi₂O₃ at 500° C. vs. average dopant ionic radius is shown in FIG. 17. While the lattice volume scaled with dopant ionic radius, the conductivity remained relatively unchanged over the stability window of the rhombohedral phase. Ultimately the lattice parameters of the rhombohedral unit cell had very little impact on the conductivity of the material.

The total dopant concentration was also varied to investigate the effect on conductivity of the rhombohedral bismuth oxide. For La and Y doped Bi₂O₃, the average dopant ionic radius was fixed at 1.12 Å and the total dopant concentration was varied between 10% and 6%. The conductivity of the rhombohedral sample vs. total dopant concentration is plotted in FIG. 18. As the cation substitution in Bi₂O₃ decreased, the oxygen ion conductivity of the material increased up to the phase boundary of the rhombohedral phase. The improvement in conductivity was again related to the overall polarizability of the cation network. Decreased cation substitution in Bi₂O₃ provided a greater concentration of the highly polarizable Bi⁺³ cations, which facilitated anion diffusion. No other investigation has minimized the total dopant concentration required to stabilize the rhombohedral phase of Bi₂O₃. By decreasing the total dopant concentration to 6.5%, the La5.1Y1.4 sample provided higher conductivity than any rhombohedral Bi₂O₃ developed to date.

Rhombohedral Bi₂O₃ Phase Transition and Ionic Transference Number

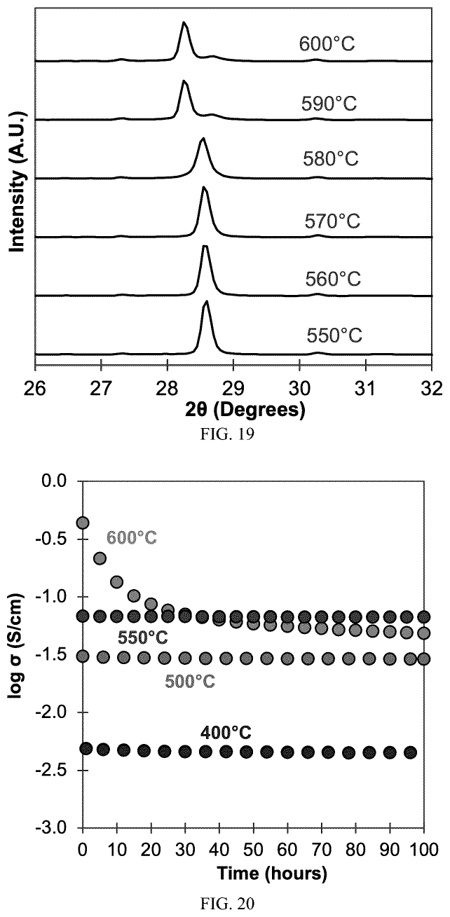

The stability of the rhombohedral La5.1Y1.4 compound was investigated over a range of temperatures. The phase stability was determined using high temperature X-ray diffraction, and conductivity stability was determined with EIS. XRD patterns of La5.1Y1.4 were recorded from room temperature up to 700° C. The XRD patterns from 550° C. to 600° C. are given in FIG. 19. Between 580° C. and 590° C. there is a clear peak shift in the XRD plot due to a phase transformation from the rhombohedral to cubic phase. From room temperature up to approximately 580° C. the rhombohedral phase is present. Above 580° C., the cubic phase grows and the rhombohedral phase shrinks until the phase is entirely cubic at 700° C. The conductivity was also measured over a range of aging temperatures to determine performance stability. The conductivity of La5.1Y1.4 as a function of aging time at 600° C., 550° C., 500° C., and 400° C. is shown in FIG. 20. From 550° C. down to 400° C. the conductivity is stable. At temperatures where Bi₂O₃ remains rhombohedral, there is almost no conductivity decay. At 600° C., the La5.1Y1.4 phase transitions from rhombohedral to cubic resulting in a degradation in conductivity when aged at 600° C. due to the ordering of the oxygen vacancies in the cubic lattice. Ultimately, stable performance of rhombohedral La5.1Y1.4 can be achieved when operation temperatures do not exceed the phase transition temperature.

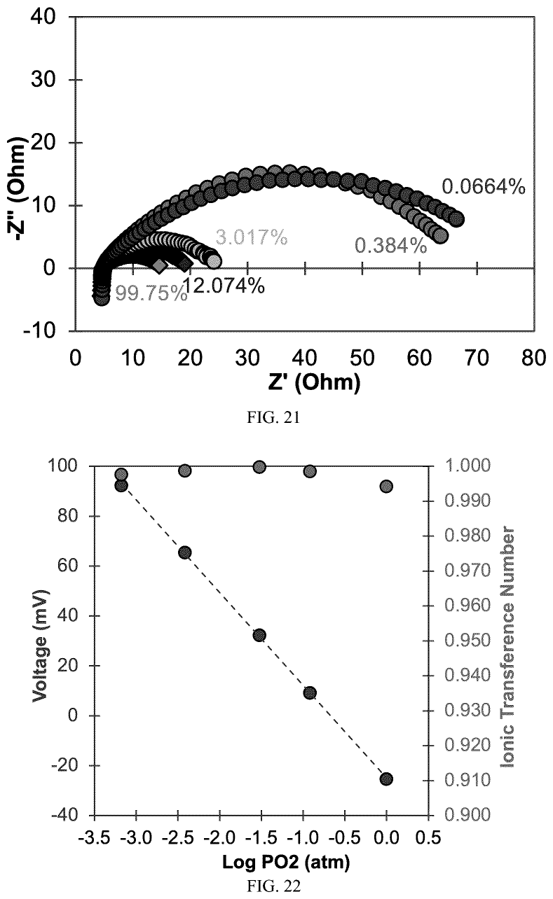

To ensure the rhombohedral La5.1Y1.4 material would be suitable as an ionic conductor, the transference number was measured. The sintered disk was sealed between two separate gas environments, and the oxygen differential generated an electrical potential. The symmetric cell was held for an hour at each condition before the V_{OC} was measured and EIS was performed. The impedance of the cell at different PO₂ values is shown in FIG. 21. The voltage as function of PO₂ and ionic transference number of La5.1Y1.4 is plotted in FIG. 22. The ionic transference number was calculated using Eq. 2, as described by Wang et al., J. Power Sources, 2008, 185, 917-921.

$${T}_{i} = 1 - \frac{{R}_{b}}{{R}_{T}} ( 1 - \frac{{V}_{O C}}{{V}_{N}} ) \qquad Eq . 2$$

In this equation, R_{b}=bulk resistance, R_{T}=total resistance, V_{OC}=open circuit voltage, and V_{N}=Nernst potential. Overall, La5.1Y1.4 demonstrated an average ionic transference number greater than 0.997 across the entire measured PO₂ range. With a transference number approaching unity, it is evident that conductivity of the rhombohedral phase resulted from ionic rather than electronic transport.

### CONCLUSION

Significant strides have been made in the development of electrolytes for SOCs operating at intermediate to low temperatures. For intermediate temperature operation (650° C.), double doped cubic Bi₂O₃ electrolytes show the greatest potential. In particular, the newly developed La7Zr3 not only demonstrated stable ionic conductivity, but it also exhibited the highest oxygen ion conductivity ever measured in any material. For low temperature operation (<600° C.), double doped rhombohedral Bi₂O₃ displayed the most promise of any electrolyte. La5.1Y1.4 is first bismuth oxide material with conductivity higher than ESB at 500° C., but with stable conductivity. In fact, La5.1Y1.4 has the highest stable oxygen ion conductivity ever recorded at low temperature. Overall, the exceptional conductivity shown here was a result of doping the larger La⁺³ cation into the lattice while simultaneously minimizing the total dopant without altering the phase of bismuth oxide. As disclosed herein, optimizing SOC electrode chemistry and overall design around these Bi₂O₃ electrolytes provided superior performance over a range of temperatures for a wide number of oxygen-functional applications.

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter. All references cited herein are incorporated by reference in their entirety.

What is claimed is:

1. A doped cubic bismuth oxide composition that is phase stable in a temperature range of from about 550° C. to about 700° C., wherein said doped cubic bismuth oxide comprises a mixture of a first dopant and a second dopant.

2. The doped cubic bismuth oxide composition of claim 1, wherein a total amount of said first and said second dopant is about 15 mole % or less of a total metal content.

3. The doped cubic bismuth oxide composition of claim 1, wherein a total amount of said first and said second dopant is about 10 mole % or less of a total metal content.

4. The doped cubic bismuth oxide composition of claim 1, wherein said doped cubic bismuth oxide has a higher conductivity than Bi_{1.76}Dy_{0.16}W_{0.08}O₃ (DWSB) at 650° C.

5. The doped cubic bismuth oxide composition of claim 1, wherein said doped cubic bismuth oxide has at least about 20% higher conductivity than Bi_{1.76}Dy_{0.16}W_{0.08}O₃ (DWSB) at 650° C.

6. The doped cubic bismuth oxide composition of claim 1, wherein said doped cubic bismuth oxide has at least about 30% higher conductivity than Bi_{1.76}Dy_{0.16}W_{0.08}O₃ (DWSB) at 650° C.

7. The doped cubic bismuth oxide composition of claim 1, wherein said first dopant comprises La, Ce, Pr, Pa, U, or a mixture thereof.

8. The doped cubic bismuth oxide composition of claim 1, wherein said second dopant comprises Zr, Y, Nb, Sn, Hf, Ta, W, or a mixture thereof.

9. A solid-oxide cell (SOC) electrolyte comprising a doped cubic bismuth oxide composition of claim 1.

10. The SOC electrolyte of claim 9, wherein said doped cubic bismuth oxide composition has at least about 20% higher conductivity at 650° C. than Bi_{1.76}Dy_{0.16}W_{0.08}O₃ (DWSB).

11. The SOC electrolyte of claim 9, wherein said doped cubic bismuth oxide composition has at least about 30% higher conductivity at 650° C. than DWSB.

12. The SOC electrolyte of claim 1, wherein said SOC electrolyte is stable at 650° C. for at least 100 hours.

13. The SOC electrolyte of claim 1, wherein said doped bismuth oxide comprises a mixture of a first dopant and a second dopant.

14. The SOC electrolyte of claim 4, wherein said first dopant comprises La, Ce, Pr, Pa, U, or a mixture thereof.

15. The SOC electrolyte of claim 4, wherein said second dopant comprises Zr, Y, Nb, Sn, Hf, Ta, W, or a mixture thereof.

16. The SOC electrolyte of claim 1, wherein an amount of a doping agent in said doped bismuth oxide comprises about 15 mole % or less.

17. The SOC electrolyte of claim 7, wherein the amount of said doping agent in said doped bismuth oxide comprises about 10 mole %.

18. The SOC electrolyte of claim 1 having an electrical conductivity of at least about 0.58 S/cm at a temperature of about 650° C. for at least about 100 hours.

19. The SOC electrolyte of claim 1, wherein said doped bismuth oxide comprises a cubic phase structure.

20. A doped bismuth oxide composition comprising bismuth oxide doped with a mixture of a first dopant and a second dopant, wherein the total amount of said first and said second dopant in said doped bismuth oxide comprises about 15 mole % or less of a total metal content, and wherein said doped bismuth oxide comprises a δ-phase bismuth oxide at a temperature of about 650° C.

21. The doped bismuth oxide composition of claim 11, wherein the total amount of said first and said second dopant in said doped bismuth oxide comprises about 10 mole % or less of the total metal content.

22. The doped bismuth oxide composition of claim 11, wherein said first dopant comprises La, Ce, Pr, Pa, U, or a mixture thereof.

23. The doped bismuth oxide composition of claim 11, wherein an amount of said first dopant ranges from about 2 mole % to about 8 mole % of the total metal content.

24. The doped bismuth oxide composition of claim 11, wherein said second dopant comprises Zr, Y, Nb, Sn, Hf, Ta, W, or a mixture thereof.

25. The doped bismuth oxide composition of claim 11, wherein an amount of said second dopant is about 3 mole % of the total metal content.

26. The doped bismuth oxide composition of claim 11, wherein said doped bismuth oxide is phase stable for at least 100 hours at a temperature of about 650° C.

27. A solid oxide fuel cell comprising a solid oxide cell electrolyte, wherein said solid oxide cell electrolyte comprises a LaZr doped cubic bismuth oxide having at least about 20% higher electric conductivity at 650° C. than Bi_{1.76}Dy_{0.16}W_{0.08}O₃ (DWSB).

28. The solid oxide fuel cell of claim 27, wherein said solid oxide cell electrolyte has at least about 30% higher electric conductivity at 650° C. than DWSB.

29. The solid oxide fuel cell of claim 27, wherein said solid oxide cell electrolyte is phase stable for at least 100 hours at 650° C.
